(19) United States
(12) Patent Application Publication
(10) Pub. No.: US 2016/0183739 A1
(43) Pub. Date: Jun. 30, 2016

(54) DISPENSER FOR DISPENSING A FLOWABLE SUBSTANCE

(71) Applicant: COLGATE-PALMOLIVE COMPANY, New York, NY (US)

(72) Inventor: John C. Crawford, Mahopac, NY (US)

(21) Appl. No.: 14/908,779

(22) PCT Filed: Aug. 8, 2013
(86) PCT No.: PCT/US2013/054117

§ 371 Date: Jan. 29, 2016

(51) Int. Cl. A47K 5/12; B05B 11/00

(52) U.S. Cl. CPC A47K 5/1211; B05B 11/0059; B05B 11/3022

(57) ABSTRACT

Disclosed is a dispenser for dispensing a flowable substance, comprising: a base having at least one contact portion lying in a first plane for stably standing the dispenser on a horizontal support surface; a holder movably connected to the base and lying in a second plane parallel to the first plane, the holder being for holding, in an inverted state, a container defining a chamber storing a flowable substance; and a conduit fluidly connecting the chamber with a discharge opening; wherein the holder is movable relative to the base to cause the flowable substance to be pumped from the chamber towards the discharge opening.

### BACKGROUND

The present invention relates to a dispenser for dispensing a flowable substance, for example a fluid personal care product such as a liquid hand soap.

It is known to provide a liquid hand soap in a chamber of a refill container and to insert the container in an inverted orientation into a dispenser having a switch and an electrically-operated pump for pumping the liquid hand soap from the chamber towards a discharge opening of the dispenser on actuation of the switch.

There is a need for a simpler and cheaper to manufacture dispenser for dispensing a flowable substance from a refill container.

### BRIEF SUMMARY

An embodiment of the present invention provides a dispenser for dispensing a flowable substance, comprising: a base having at least one contact portion lying in a first plane for stably standing the dispenser on a horizontal support surface; a holder movably connected to the base and lying in a second plane above the first plane, the holder being for holding, in an inverted state, a container defining a chamber storing a flowable substance; and a conduit fluidly connecting the chamber with a discharge opening; wherein the holder is movable relative to the base to cause the flowable substance to be pumped from the chamber towards the discharge opening.

Optionally, the discharge opening lies in a third plane above the second plane, wherein the second plane is between the first and third planes.

Optionally, the holder is movable manually relative to the base to cause the flowable substance to be pumped from the chamber towards the discharge opening. Further optionally, the holder is movable manually relative to the base to cause the flowable substance to be pumped manually from the chamber towards the discharge opening.

Optionally, the dispenser further comprises a cavity for receiving the flowable substance from the chamber of the container.

Optionally, the cavity is at least partially defined by the base and/or by the holder.

Optionally, the cavity is at least partially defined by a bellows.

Optionally, the dispenser comprises a first valve configured to permit fluid flow from the chamber to the cavity and to prevent or hinder fluid flow from the cavity to the chamber.

Optionally, the dispenser comprises a second valve configured to permit fluid flow from the cavity to the discharge opening and to prevent or hinder fluid flow from the discharge opening to the cavity.

Optionally, the holder is movable relative to the base to cause a volume of the cavity to be reduced, thereby to cause the flowable substance to be pumped through the cavity towards the discharge opening.

Optionally, the holder is movable towards the base to cause the flowable substance to be pumped from the chamber towards the discharge opening.

Optionally, the holder is movable in a direction orthogonal to the second plane to cause the flowable substance to be pumped from the chamber towards the discharge opening.

Optionally, the holder is biased away from the base.

Optionally, a ratio of a distance between the second and third planes and a distance between the first and second planes is greater than or equal to 1:1. Further optionally, the ratio is greater than or equal to 2:1. Further optionally, the ratio is greater than or equal to 3:1. Still further optionally, the ratio is greater than or equal to 4:1.

Optionally, the holder includes a securing device for securing the container to the holder. Further optionally, the securing device is for removably securing the container to the holder. Still further optionally, the securing device comprises a screw thread, optionally the screw thread is a female screw thread.

Optionally, the discharge opening faces towards the second plane.

Optionally, the base defines a hollow within which at least a portion of the container is disposed when the container is held in an inverted state by the holder.

Optionally, the dispenser comprises the container held by the holder, wherein application of a force by a user on the container in a direction towards the base causes movement of the container and the holder towards the base, thereby causing the flowable substance to be pumped from the chamber to the discharge opening. Further optionally, there is provided a seal between the holder and the container.

Optionally, the flowable substance comprises a fluid personal care product. Further optionally, the flowable substance comprises a fluid personal care product selected from a liquid hand soap, a dentifrice, a hair care product, and a body wash.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a cross sectional view of a dispenser according to an exemplary embodiment of the present invention;

FIG. 2 shows a cross sectional view of a dispenser according to another exemplary embodiment of the present invention; and

FIG. 3 shows a cross sectional view of a dispenser according to another exemplary embodiment of the present invention.

### DETAILED DESCRIPTION

The following description of the preferred embodiment(s) is merely exemplary in nature and is in no way intended to limit the invention, its application, or uses.

As used throughout, ranges are used as shorthand for describing each and every value that is within the range. Any value within the range can be selected as the terminus of the range. In addition, all references cited herein are hereby incorporated by referenced in their entireties. In the event of a conflict in a definition in the present disclosure and that of a cited reference, the present disclosure controls.

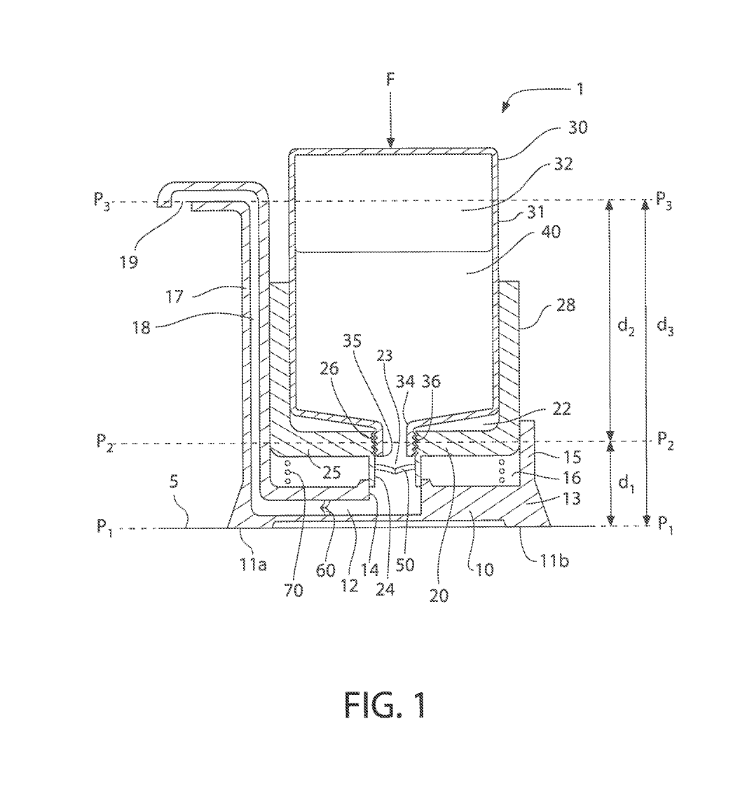

FIG. 1 shows a cross sectional view of the components of a dispenser 1 of an exemplary embodiment of the present invention. Briefly, the dispenser 1 comprises a base 10, a holder 20 movably connected to the base 10, a container 30, first and second one-way valves 50, 60, and a biasing device 70, each of which will be described in turn.

A first portion 13 of the base 10 has a plurality of contact portions 11a, 11b lying in a first plane P₁-P₁ for stably standing the base 10 and the rest of the dispenser 1 on a horizontal support surface 5. In a variation to the illustrated embodiment, the base may have only one such contact portion 11. For example, the base 10 may have a flat underside for contacting the horizontal support surface 5 or may have only one annular contact portion 11 for contacting the horizontal support surface 5. Other configurations of contact portion(s) will be apparent to the skilled person. The first portion 13 of the base 10 partially defines or delimits a cavity 12 and a socket 14 in fluid communication with the cavity 12.

Extending from the first portion 13 of the base 10 is an annular second portion 15 of the base 10, which second portion 15 defines and surrounds a hollow 16. In a variation to the illustrated embodiment, the second portion 15 of the base 10 is not fully annular, but may comprise a plurality of parts that lie on an annular path. Extending from the second portion 15, at one side of the hollow 16, the base 10 further comprises a tubular portion 17 that defines a passageway 18 and a discharge opening 19. At a first end of the passageway 18 is the second one-way valve 60, and at a second end of the passageway 18 is the discharge opening 19. Looked at another way, the passageway 18 fluidly connects the second one-way valve 60 with the discharge opening 19. The second one-way valve 60 lies between the cavity 12 and the passageway 18 to selectively isolate the cavity 12 from the passageway 18, thereby to selectively isolate the cavity 12 from the discharge opening 19, as will be described in more detail below.

The discharge opening 19 lies in a third plane P₃-P₃ parallel to the first plane P₁-P₁ with a third distance d₃ between the first plane P₁-P₁ and the third plane P₃-P₃. The third distance d₃ is selected so as to permit a user to locate their hands within a gap between the first and third planes, i.e. between the discharge opening 19 and the horizontal support surface 5. In the illustrated embodiment, the third distance d₃ is 15 cm. However, in variations to the illustrated embodiment, the third distance d₃ may be, for example, any one of at least 10 cm, at least 15 cm and at least 20 cm.

A first portion 25 of the holder 20 is disposed within the hollow 16 defined by and surrounded by the second portion 15 of the base 10. The first portion 25 of the holder 20 is a snug fit within the hollow 16, but the holder 20 remains freely manually movable relative to the base 10 in a substantially linear direction, as will be described below.

The first portion 25 of the holder 20 lies in a second plane P₂-P₂ above the first plane P₁-P₁ with a first distance d₁ between the first plane P₁-P₁ and the second plane P₂-P₂. It follows that the second plane P₂-P₂ lies above the third plane P₃-P₃ with a second distance d₂ between the second plane P₂-P₂ and the third plane P₃-P₃, and that the third distance d₃ is the sum of the first distance d₁ and the second distance d₂. In the illustrated embodiment, the first distance d₁ is 5 cm and the second distance d₂ is 10 cm, so that a ratio of the second distance d₂ and the first distance d₁ is 2:1. However, in variations to the illustrated embodiment, the ratio may be, for example, any one of greater than or equal to 1:1, greater than 2:1, greater than or equal to 3:1, and greater than or equal to 4:1. It will be noted that the discharge opening 19 discussed above faces towards the second plane P₂-P₂ and the first plane P₁-P₁, although in other embodiments the discharge opening 19 could face in a different direction, such as in a direction parallel or along the third plane P₃-P₃. In certain embodiments, the first plane P₁-P₁, the second plane P₂-P₂ and the third plane P₃-P₃ are parallel to one another.

Extending from the first portion 25 of the holder 20 is an annular second portion 28 of the holder 20, which second portion 28 defines and surrounds a space 22 for receiving a portion of the container 30. In a variation to the illustrated embodiment, the second portion 28 of the holder 20 is not fully annular, but may comprise a plurality of parts that lie on an annular path. Extending from the first portion 25 of the holder 20, in a direction opposite to that in which the second portion 28 of the holder 20 extends from the first portion 25 of the holder 20, the holder 20 further comprises a tube 24 that defines a passage 23. At a first end of the passage 23 is the space 22, and at a second end of the passage 23 is the first one-way valve 50. Looked at another way, the passage 23 fluidly connects the space 22 with the first one-way valve 50. The first one-way valve 50 lies between the passage 23 and the cavity 12 to selectively isolate the passage 23 from the cavity 12, thereby to selectively isolate the space 22 from the cavity 12, as will be described in more detail below.

The tube 24 of the holder 20 is slidably disposed within the socket 14 defined by the first portion 13 of the base 10. The tube 24 of the holder 20 partially defines or delimits the cavity 12. That is, the cavity 12 is defined or delimited by the first portion 13 of the base 10 and the tube 24 of the holder 20. The first and second one-way valves 50, 60 also act to partially define or delimit the cavity 12. The cavity 12 is thus defined or delimited by the combination of the base 10, the holder 20 and the first and second one-way valves 50, 60. Although not shown in the Figure, a seal is provided between the tube 24 of the holder 20 and the first portion 13 of the base 10, which seal does not hinder movement of the holder 20 relative to the base 10.

The container 30 comprises a body 31 partially disposed in the space 22 and defining a chamber 32 storing a flowable substance 40, i.e. a substance that is able to flow at room temperature and atmospheric pressure. Moreover, herein, by “room temperature” it is meant a temperature of 20 to 25 degrees Celsius, and by “atmospheric pressure” it is meant a pressure of 101 kPa. The body 31 is a snug fit within the space 22. In the illustrated embodiment, the flowable substance 40 is a liquid hand soap, but in variations to the illustrated embodiment the flowable substance 40 may be a different type of personal care product, such as a dentifrice, a hair care product, or a body wash. The container 30 further has a neck 34 that is unitary with the body 31 and defines an opening 35 through which the flowable substance 40 is dispensable from the chamber 32. The neck 34 of the container 30 is disposed within the hollow 16 defined by and surrounded by the second portion 15 of the base 10.

The container 30 is disposed in an inverted state, that is with the opening 35 below the chamber 32 or closer to the first plane P₁-P₁ and the horizontal support surface 5 than the chamber 32. Accordingly, the flowable substance 40 tends to move from the chamber 32 to the opening 35 under the influence of gravity. On an exterior side of the neck 34 there is provided a male screw thread 36 for cooperating or mating with a female screw thread 26 defined by the first portion 25 of the holder 20. The male and female screw threads 36, 26 are respective securing devices of the container 30 and the holder 20 for removably securing the container 30 to the holder 20. Moreover, the male and female screw threads 36, 26 act to provide a seal between the container 30 and the holder 20. In a variation to the illustrated embodiment, such a seal may be provided by a component discrete from the container 30 and the holder 20, such as a rubber or elastomeric member. In another variation to the illustrated embodiment, the container 30 is secured to the holder 20 via a snap-fit configuration or other appropriate mechanical engagement.

With the container 30 in place and secured to the holder 20 as shown in FIG. 1, the second portion 28 of the holder 20 and the female screw thread 26 defined by the first portion 25 of the holder 20 act to hold or support the container 30 in place relative to the holder 20. Moreover, with the container 30 secured to the holder 20 as shown in FIG. 1, the passage 23 is isolated from the space 22 by the container 30. Accordingly, at the first end of the passage 23 is the opening 35 and the chamber 32 of the container 30, and the passage 23 fluidly connects the opening 35 and the chamber 32 with the first one-way valve 50. Moreover, the first one-way valve 50 lies between the passage 23 and the cavity 12 to selectively isolate the passage 23 from the cavity 12, thereby to selectively isolate the opening 35 and the chamber 32 from the cavity 12, as will be described in more detail below.

The cavity 12 is for receiving the flowable substance 40 from the chamber 32 of the container 30 via the first one-way valve 50. The first one-way valve 50 is configured to permit fluid flow from the chamber 32 of the container 30 to the cavity 12 and to prevent or hinder fluid flow from the cavity 12 to the chamber 32. The second one-way valve 60 is configured to permit fluid flow from the cavity 12 to the discharge opening 19 and to prevent or hinder fluid flow from the discharge opening 19 to the cavity 12.

The biasing device 70, in the form of a coil spring, connects the first portion 25 of the holder 20 to the first portion 13 of the base 10 and biases the holder 20 away from the base 10. In a variation to the illustrated embodiment, the biasing device 70 may comprise more than one coil spring or may take a different form. For example, the biasing device 70 may comprise a block of resilient material.

The combination of the passage 23, the cavity 12 and the passageway 18 is considered herein as a conduit, which conduit fluidly connects the chamber 32 of the container 30 with the discharge opening 19.

With the dispenser 1 so constructed, the holder 20 is movable manually relative to the base 10 to cause a volume of the cavity 12 to be varied. More specifically, application of a force by a user on the container 30, with at least a component of the force in a direction towards the base 10 (as indicated by arrow F in FIG. 1), and against the bias of the biasing device 70, causes movement of the container 30 and the holder 20 towards the base 10, and thus movement of the tube 24 further into the socket 14 defined by the first portion 13 of the base 10, thereby to cause the volume of the cavity 12 to be reduced. Such movement is in a direction orthogonal to each of the first, second and third planes. Reduction in the volume of the cavity 12 causes an increase in pressure in the cavity 12, which forces the first one-way valve 50 to close to prevent any fluid (such as air and/or the flowable substance 40) in the cavity 12 from passing into the passage 23 and chamber 32. However, the increase in pressure forces the second one-way valve 60 to open and causes any fluid (such as air and/or the flowable substance 40) in the cavity 12 to pass into the passageway 18. Subsequent reduction or removal of the force allows the biasing device 70 to urge the holder 20 away from the base 10, thereby to dispose the tube 24 less far into the socket 14 and to increase the volume of the cavity 12. Increase in the volume of the cavity 12 causes a reduction in pressure in the cavity 12, which forces the second one-way valve 60 to close to prevent any fluid (such as air and/or the flowable substance 40) in the cavity 12 from passing into the passageway 18. However, the reduction in pressure means that the pressure in the chamber 32 of the container 30 becomes greater than the pressure in the cavity 12. Accordingly, the first one-way valve 50 is forced open and a volume of the flowable substance 40 in the chamber 32 of the container 30 is pushed or drawn into the cavity 12 via the passage 23 and the first one-way valve 50. Re-application of the force causes repetition of these motions, so that there is net movement of the flowable substance 40 from the chamber 32 of the container 30 to the discharge outlet 19, via the passage 23, the cavity 12, and the passageway 18, in that order. In some embodiments, there may be a pressure relieve mechanism such as a relieve valve located in a part of the container 30 to relieve the pressure within the chamber 32 if necessary.

Thus, such manual movement of the holder 20 towards the base 10 causes the flowable substance 40 to be pumped manually through the cavity 12, indeed through the conduit, from the chamber 32 of the container 30 towards the discharge opening 19.

Moreover, when most or all of the flowable substance 40 in the chamber 32 has been so dispensed, the container 30 can be replaced. To do this, the user rotates the container 30 relative to the holder 20 to disconnect the male screw thread 36 of the container 30 from the female screw thread 26 of the holder 20. The user then removes the container 30 from the space 22 and disposes of the container 30. Preferably the container 30 is made of a recyclable material, and the user sends the container 30 for recycling. The user then re-assembles the dispenser 1 by inverting a container 30 containing more flowable substance 40, aligning the male screw thread 36 of the container 30 with the female screw thread 26 of the holder 20, and rotating the container 30 relative to the holder 20 to engage the male screw thread 36 with the female screw thread 26.

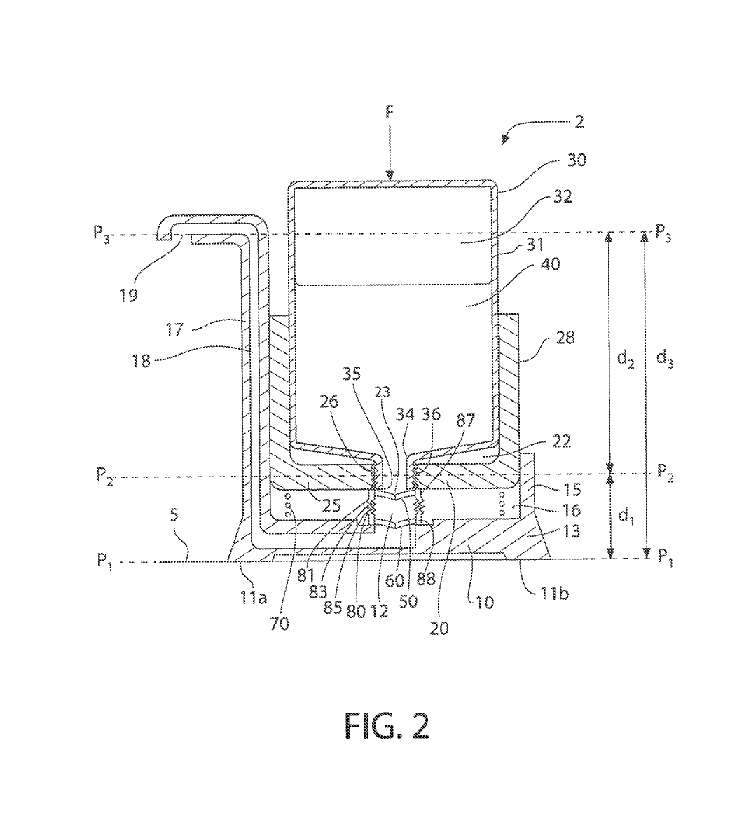

FIG. 2 shows a cross sectional view of the components of a dispenser 2 of another exemplary embodiment of the present invention. The dispenser 2 of FIG. 2 is the same as the dispenser 1 of FIG. 1, except for the manner in which the cavity 12 is defined and the positions of the first and second one-way valves 50, 60. Like components in FIGS. 1 and 2 have like reference numerals and will not be described again for conciseness.

The dispenser 2 of FIG. 2 comprises a vessel 80 connected between the base 10 and the holder 20. The vessel 80 comprises a bellows that is deformable according to a predetermined pattern of collapse. In particular, the vessel 80 comprises an annular wall comprising relatively larger diameter sections 81, 83, 85 interspaced with relatively smaller diameter sections. The relatively larger and smaller diameter sections are movable towards and away from each other in an axial direction of the annular wall, so that the bellows is collapsible and expandable in the axial direction of the annular wall.

The vessel 80 has a first end 87 connected to the holder 20 and a second end 88 connected to the base 10, the first and second ends 87, 88 being disposed at opposite ends of the cavity 12 defined by the vessel 80. The vessel 80 comprises a first one-way valve 50 at the first end 87 of the vessel 80, which first valve 50 is configured to permit fluid flow from the chamber 32 of the container 30 to the cavity 12 and to prevent or hinder fluid flow from the cavity 12 to the chamber 32. The vessel 80 also comprises a second one-way valve 60 at the second end 88 of the vessel 80, which second valve 60 is configured to permit fluid flow from the cavity 12 to the passageway 18 and discharge opening 19 and to prevent or hinder fluid flow from the passageway 18 and discharge opening 19 to the cavity 12.

The vessel 80 defines the cavity 12, which selectively fluidly connects the passage 23 to the passageway 18 via the first and second one-way valves 50, 60. More specifically, the cavity 12 is defined or delimited by the first and second one-way valves 50, 60 and the bellows of the vessel 80. Deformation of the bellows of the vessel 80 causes a volume of the cavity 12 to be varied. Accordingly, the cavity 12 is of variable volume. More specifically, when the bellows is collapsed, the volume of the cavity 12 is reduced, whereas when the bellows is expanded, the volume of the cavity 12 is increased.

The first and second valves 50, 60 may be attached to a pre-formed bellows. For example, one or both of the first and second valves 50, 60 may be inserted into, adhered to, or otherwise fixed to, the respective first and second ends 87, 88 of the vessel 80 after manufacture of the bellows. In other embodiments, one or both of the first and second valves 50, 60 may be unitary with the bellows; that is, one or both of the first and second valves 50, 60 may be integrally formed with the bellows at the same time as the bellows is formed.

The combination of the passage 23, the cavity 12 and the passageway 18 is considered herein as a conduit, which conduit fluidly connects the chamber 32 of the container 30 with the discharge opening 19.

With the dispenser 2 so constructed, the holder 20 is movable manually relative to the base 10 to cause a volume of the cavity 12 to be varied. More specifically, application of a force by a user on the container 30, with at least a component of the force in a direction towards the base 10 (as indicated by arrow F in FIG. 2), and against the bias of the biasing device 70, causes movement of the container 30 and the holder 20 towards the base 10, and thus collapse of the bellows, thereby to cause the volume of the cavity 12 to be reduced. Such movement is in a direction orthogonal to each of the first, second and third planes. Reduction in the volume of the cavity 12 causes an increase in pressure in the cavity 12, which forces the first one-way valve 50 to close to prevent any fluid (such as air and/or the flowable substance 40) in the cavity 12 from passing into the passage 23 and chamber 32. However, the increase in pressure forces the second one-way valve 60 to open and causes any fluid (such as air and/or the flowable substance 40) in the cavity 12 to pass into the passageway 18. Subsequent reduction or removal of the force allows the biasing device 70 to urge the holder 20 away from the base 10, thereby to expand the bellows and to increase the volume of the cavity 12. Increase in the volume of the cavity 12 causes a reduction in pressure in the cavity 12, which forces the second one-way valve 60 to close to prevent any fluid (such as air and/or the flowable substance 40) in the cavity 12 from passing into the passageway 18. However, the reduction in pressure means that the pressure in the chamber 32 of the container 30 becomes greater than the pressure in the cavity 12. Accordingly, the first one-way valve 50 is forced open and a volume of the flowable substance 40 in the chamber 32 of the container 30 is pushed or drawn into the cavity 12 via the passage 23 and the first one-way valve 50. Re-application of the force causes repetition of these motions, so that there is net movement of the flowable substance 40 from the chamber 32 of the container 30 to the discharge outlet 19, via the passage 23, the cavity 12, and the passageway 18, in that order.

Thus, such manual movement of the holder 20 towards the base 10 causes the flowable substance 40 to be pumped manually through the cavity 12, indeed through the conduit, from the chamber 32 of the container 30 towards the discharge opening 19.

Moreover, when most, or all, of the flowable substance 40 in the chamber 32 has been so dispensed, the container 30 can be replaced in the same manner as the container 30 of the dispenser 1 shown in FIG. 1.

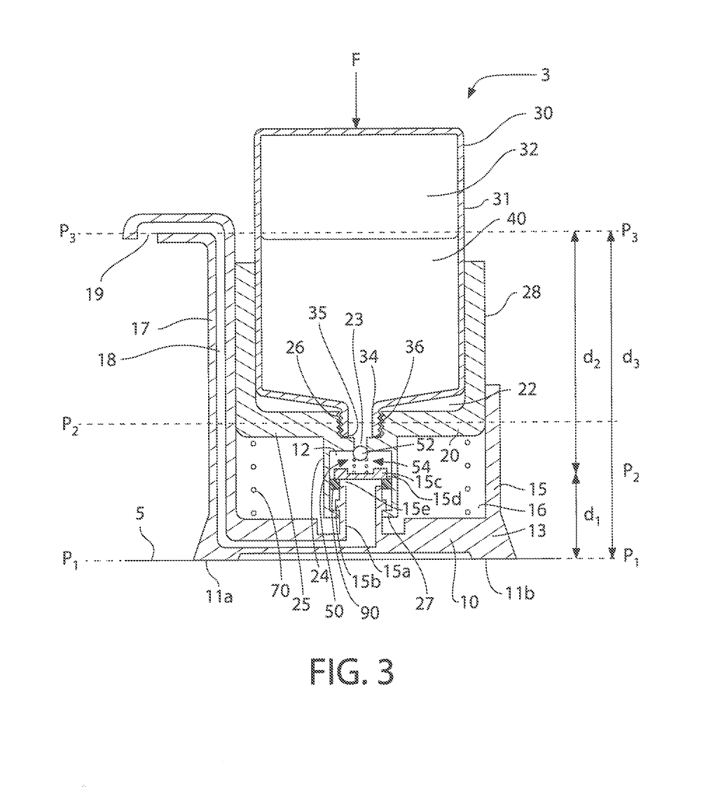

FIG. 3 shows a cross sectional view of the components of a dispenser 3 of another exemplary embodiment of the present invention. Like components in FIGS. 1 and 3 have like reference numerals and will not be described again for conciseness.

Extending from the first portion 25 of the holder 20, in a direction opposite to that in which the second portion 28 of the holder 20 extends from the first portion 25 of the holder 20, the holder 20 comprises a tube 24 that defines a passage 23. At a first end of the passage 23 is the space 22, and at a second end of the passage 23 is a one-way valve 50. Looked at another way, the passage 23 fluidly connects the space 22 with the one-way valve 50. With the container 30 secured to the holder 20 as shown in FIG. 3, the passage 23 is isolated from the space 22 by the container 30. Accordingly, at the first end of the passage 23 is the opening 35 and the chamber 32 of the container 30, and the passage 23 fluidly connects the opening 35 and the chamber 32 with the one-way valve 50. The one-way valve 50 will be described in more detail below.

Within the hollow 16, and extending from the first portion 13 of the base 10, is a tubular portion 15a of the base 10. The interior of the tubular portion 15a is in fluid communication with the passageway 18, and a portion of the tubular portion 15a is disposed within the tube 24 of the holder 20. A radially outwardly extending first annular flange 15b extends from the tubular portion 15a within the tube 24. A radially inwardly extending annular flange 27 extends from the tube 24 and contacts the tubular portion 15a of the base 10 between the first annular flange 15b and the first portion 13 of the base 10. Preferably a seal is created between the annular flange 27 and the tubular portion 15a of the base 10, which seal permits relative movement of the tube 24 and the tubular portion 15a.

The tubular portion 15a has a closed upper axial end 15c, and a circumferential opening 15e extending through a circumferential side of the tubular portion 15a adjacent the upper axial end 15c. The opening 15e fluidly connects the interior of the tubular portion 15a with the interior of the tube 24. An annular seal 90 is disposed radially outward of the tubular portion 15a and radially inward of the tube 24, and is movable relative to the tubular portion 15a between a first position at which the annular seal 90 blocks the opening 15e (as shown in FIG. 3) and a second position at which the opening 15e is not blocked by the annular seal 90. Accordingly, the opening 15e and the annular seal 90 together form a second valve. The annular seal 90 may be made of an elastomer or rubber. Opposite axial sides of the annular seal 90 are isolated by the annular seal 90 and its contact with the tubular portion 15a and the tube 24. A coefficient of friction between the annular seal 90 and the tube 24 is greater than a coefficient of friction between the annular seal 90 and the tubular portion 15a. Accordingly, during relative movement of the tube 24 and the tubular portion 15a, the annular seal 90 tends to move with the tube 24 relative to the tubular portion 15a.

The one-way valve 50 comprises a plug 52 and a resilient device 54. In this embodiment, the plug 52 is a ball and the resilient device 54 is a coil spring, but the plug 52 and/or the resilient device 54 could take other forms in other embodiments. Together, the tubular portion 15a, the tube 24, the annular seal 90 and the plug 52 define a cavity 12, which selectively fluidly connects the passage 23 to the passageway 18 via the one-way valve 50 and the second valve. Movement of the holder 20 relative to the base 10 causes a volume of the cavity 12 to be varied. Accordingly, the cavity 12 is of variable volume. More specifically, when the holder 20 is moved towards the base 10, the volume of the cavity 12 is reduced, whereas when the holder 20 is moved away from the base 10, the volume of the cavity 12 is increased.

The one-way valve 50 is configured to permit fluid flow from the chamber 32 of the container 30 to the cavity 12 and to prevent or hinder fluid flow from the cavity 12 to the chamber 32. More specifically, the plug 52 is movable relative to the tube 24 between a first position at which the plug 52 isolates the passage 23 from the cavity 12 (as shown in FIG. 3) and a second position at which the plug 52 permits fluid communication between the passage 23 and the cavity 12. A first end of the resilient device 54 abuts the closed upper axial end of the tubular portion 15a, and a second end of the resilient device 54 abuts the plug 52. The resilient device 54 biases the plug 52 to the first position.

The combination of the passage 23, the cavity 12 and the passageway 18 is considered herein as a conduit, which conduit fluidly connects the chamber 32 of the container 30 with the discharge opening 19.

With the dispenser 3 so constructed, application of a force by a user on the container 30, with at least a component of the force in a direction towards the base 10 (as indicated by arrow F in FIG. 3), and against the bias of the biasing device 70, causes movement of the container 30, the holder 20 and the annular seal 90 towards the base 10, thereby to cause the volume of the cavity 12 to be reduced. Such movement is in a direction orthogonal to each of the first, second and third planes. Reduction in the volume of the cavity 12 causes an increase in pressure in the cavity 12, which forces the plug 52 to remain in its first position to prevent any fluid (such as air and/or the flowable substance 40) in the cavity 12 from passing into the passage 23 and chamber 32. However, the movement causes the annular seal 90 to move from the first position to the second position, which permits any fluid (such as air and/or the flowable substance 40) in the cavity 12 to pass into the passageway 18. More specifically, during the movement, the annular seal 90 first moves with the tube 24 until the annular seal 90 contacts the first annular flange 15b, and then the tube 24 continues to move relative to the annular seal 90 and the tubular portion 15a.

Subsequent reduction or removal of the force allows the biasing device 70 to urge the holder 20 and the annular seal 90 away from the base 10, thereby to increase the volume of the cavity 12. The movement causes the annular seal 90 to move from the second position to the first position at which the opening 15e is blocked by the annular seal 90, which prevents any fluid (such as air and/or the flowable substance 40) to pass between the cavity 12 and the passageway 18. More specifically, during this movement, the annular seal 90 first moves with the tube 24 until the annular seal 90 contacts a radially outwardly extending second annular flange 15d that extends from the tubular portion 15a at the upper axial end 15c, and then the tube 24 continues to move relative to the annular seal 90 and the tubular portion 15a. Increase in the volume of the cavity 12 causes a reduction in pressure in the cavity 12, which means that the pressure in the chamber 32 of the container 30 becomes greater than the pressure in the cavity 12. Accordingly, the plug 52 is forced to its second position against the bias of the resilient device 54 and a volume of the flowable substance 40 in the chamber 32 of the container 30 is pushed or drawn into the cavity 12 via the passage 23 and the one-way valve 50. Re-application of the force causes repetition of these motions, so that there is net movement of the flowable substance 40 from the chamber 32 of the container 30 to the discharge outlet 19, via the passage 23, the cavity 12, and the passageway 18, in that order.

Thus, such manual movement of the holder 20 towards the base 10 causes the flowable substance 40 to be pumped manually through the cavity 12, indeed through the conduit, from the chamber 32 of the container 30 towards the discharge opening 19.

Moreover, when most, or all, of the flowable substance 40 in the chamber 32 has been so dispensed, the container 30 can be replaced in the same manner as the container 30 of the dispenser 1 shown in FIG. 1.

The dispenser 1, 2, 3 may be supplied either (a) with the container 30 secured to the holder 20 as discussed above, (b) with the container 30 but without the container 30 being secured to the holder 20, or (c) without any container 30. One or more of the containers 30 storing therein the flowable substance 40 may be supplied separately to the rest of the dispenser 1, 2, 3. A plurality of the containers 30 storing therein the flowable substance 40 may be provided together in a bundle or package for convenience.

Accordingly, there is provided an example of a simpler and cheaper to manufacture dispenser for dispensing a flowable substance from a refill container according to the present invention.

1. A dispenser for dispensing a flowable substance, comprising:
a base having at least one contact portion lying in a first plane for stably standing the dispenser on a horizontal support surface;
a holder movably connected to the base and lying in a second plane above the first plane, the holder being for holding, in an inverted state, a container defining a chamber storing a flowable substance; and
a conduit fluidly connecting the chamber with a discharge opening;
wherein the holder is movable relative to the base to cause the flowable substance to be pumped from the chamber towards the discharge opening.

2. The dispenser of claim 1, wherein the discharge opening lies in a third plane above the second plane, wherein the second plane is between the first and third planes.

3. The dispenser of claim 1, wherein the holder is movable manually relative to the base to cause the flowable substance to be pumped from the chamber towards the discharge opening.

4. The dispenser of claim 3, wherein the holder is movable manually relative to the base to cause the flowable substance to be pumped manually from the chamber towards the discharge opening.

5. The dispenser of claim 1, further comprising a cavity for receiving the flowable substance from the chamber of the container.

6. The dispenser of claim 5, wherein the cavity is at least partially defined by the base and/or by the holder.

7. The dispenser of claim 5, wherein the cavity is at least partially defined by a bellows.

8. The dispenser of claim 5, comprising a first valve configured to permit fluid flow from the chamber to the cavity and to prevent or hinder fluid flow from the cavity to the chamber.

9. The dispenser of claim 5, comprising a second valve configured to permit fluid flow from the cavity to the discharge opening and to prevent or hinder fluid flow from the discharge opening to the cavity.

10. The dispenser of claim 5, wherein the holder is movable relative to the base to cause a volume of the cavity to be reduced, thereby to cause the flowable substance to be pumped through the cavity towards the discharge opening.

11. The dispenser of claim 1, wherein the holder is movable towards the base to cause the flowable substance to be pumped from the chamber towards the discharge opening.

12. The dispenser of claim 1, wherein the holder is movable in a direction orthogonal to the second plane to cause the flowable substance to be pumped from the chamber towards the discharge opening.

13. The dispenser of claim 1, wherein the holder is biased away from the base.

14. The dispenser of claim 1, wherein a ratio of a distance between the second and third planes and a distance between the first and second planes is greater than or equal to 1:1.

15. The dispenser of claim 1, wherein the holder includes a securing device for securing the container to the holder.

16. The dispenser of claim 15, wherein the securing device comprises a screw thread.

17. The dispenser of claim 1, wherein the discharge opening faces towards the second plane.

18. The dispenser of claim 1, wherein the base defines a hollow within which at least a portion of the container is disposed when the container is held in an inverted state by the holder.

19. The dispenser of claim 1, comprising the container held by the holder, wherein application of a force by a user on the container in a direction towards the base causes movement of the container and the holder towards the base, thereby causing the flowable substance to be pumped from the chamber to the discharge opening.

20. The dispenser of claim 19, comprising a seal between the holder and the container.

21. The dispenser of claim 1, wherein the flowable substance comprises a fluid personal care product.
